(19) United States
(12) Patent Application Publication
(10) Pub. No.: US 2023/0367741 A1
(43) Pub. Date: Nov. 16, 2023

(54) GPU AND METHOD OF THE SAME

(71) Applicant: ALIBABA (CHINA) CO., LTD., ZHEJIANG PROVINCE (CN)

(72) Inventors: HAORAN LI, Shanghai (CN); FEI SUN, SAN JOSE, CA (US); YUAN GAO, Shanghai (CN); GUYUE HUANG, Shanghai (CN); RUIGUANG ZHONG, Shanghai (CN); CHEN ZHANG, Shanghai (CN)

(21) Appl. No.: 17/937,973

(22) Filed: Oct. 4, 2022

(30) Foreign Application Priority Data
May 16, 2022 (CN) 202210533717.7

(51) Int. Cl. G06F 15/82; G06F 9/30

(52) U.S. Cl. CPC G06F 15/82; G06F 9/3013

(57) ABSTRACT

The present application discloses a GPU and a method of the same. The GPU includes: a plurality of streaming multiprocessor (SMs), each including: a plurality of streaming processors (SPs), each including a register, wherein each SP has a predetermined upper bound of warp number, and the register has a predetermined upper bound of register capacity; and a global dispatcher, including: a register occupancy status table, for recording the warp number and an occupancy status of the register of each SP of each SM; a TB (TB) dispatch module, for dispatching the TB to a first SM of the SMs according to a warp type classification table and the register occupancy status table; and a warp dispatch module, for dispatching a plurality of warps to the plurality of SPs of the first SM according to the warp type classification table and the register occupancy status table.

### CROSS-REFERENCE TO RELATED APPLICATIONS

This application claims priority to China Application Serial Number 202210533717.7, filed on May 16, 2022, which is incorporated by reference in its entirety.

### TECHNICAL FIELD

The present application relates to a processor and particularly to a GPU a method of the same.

### BACKGROUND

When a GPU executes kernel code, it executes on a streaming processor (SP) with a warp as the unit. As the warp is scheduled to the SP, it takes up space in the registers on the SP. In other words, the limited register space is one of the bottlenecks in the number of warps that can be scheduled to the SP, which is an urgent issue to be addressed in the related field.

### SUMMARY

One purpose of the present disclosure is to disclose a GPU and a method of the same to address the above-mentioned issues.

One embodiment of the present disclosure discloses a GPU, configured to execute a kernel code, wherein the kernel code includes a thread block (TB), and the TB includes a plurality of warps, the GPU includes: a plurality of streaming multiprocessor (SMs), each SM includes: a plurality of streaming processors (SPs), wherein each of the plurality of SPs includes a register, wherein each of the SPs has predetermined upper bound of warp number, and the register has predetermined upper bound of register capacity; and a global dispatcher, including: a register occupancy status table, configured to record a warp number and an occupancy status of the register of each SP of each SM; a TB dispatch module, configured to dispatch the TB to a first SM of the plurality of SMs according to a warp type classification table and the register occupancy status table; and a warp dispatch module, configured to dispatch the plurality of warps to the plurality of SPs of the first SM according to the warp type classification table and the register occupancy status table.

One embodiment of the present disclosure discloses a method, including: receiving a kernel code, wherein the kernel code includes a TB, and the TB includes a plurality of warps; classifying the plurality of warps into a plurality of different types according to a function of the plurality of warps; analyzing a register space required by each type of the warp when being executed; and recording in a warp type classification table the types of the plurality of warps and the register space required by the plurality of warps when being executed.

The GPU and the method of the same disclosed in the present application can optimize the space usage of the register in the SP and thus increase the performance of the GPU.

### BRIEF DESCRIPTION OF THE DRAWINGS

FIG. 1 is a schematic diagram illustrating a GPU according to embodiments of the present disclosure.

FIG. 2 is a flowchart illustrating a method performed by a complier according to embodiments of the present disclosure.

FIG. 3 is a schematic diagram illustrating a warp type classification table of FIG. 1 according to embodiments of the present disclosure.

FIG. 4 is a schematic diagram illustrating a register occupancy status table of FIG. 1 according to embodiments of the present disclosure.

FIG. 5a to FIG. 5o are schematic diagrams illustrating a warp dispatch module dispatching a plurality of warps to the plurality of SPs according to embodiments of the present disclosure.

### DETAILED DESCRIPTION

The following disclosure provides many different embodiments or examples for implementing different features of the present disclosure. Specific examples of components and arrangements are described below to simplify the present disclosure. As could be appreciated, these are merely examples and are not intended to be limiting. For example, the formation of a first feature over or on a second feature in the description that follows may include embodiments in which the first and second features are formed in direct contact and may also include embodiments in which additional features may be formed between the first and second features, such that the first and second features may not be in direct contact. In addition, the present disclosure may repeat reference numerals and/or letters in the various embodiments. This repetition is for the purpose of simplicity and clarity and does not in itself dictate a relationship between the various embodiments and/or configurations discussed.

Further, spatially relative terms, such as “beneath,” “below,” “lower,” “above,” “upper,” and the like, may be used herein for ease of description to discuss one element or feature's relationship to another element (s) or feature (s) as illustrated in the drawings. These spatially relative terms are intended to encompass different orientations of the device in use or operation in addition to the orientation depicted in the drawings. The apparatus may be otherwise oriented (e.g., rotated by 90 degrees or at other orientations), and the spatially relative descriptors used herein may likewise be interpreted accordingly.

Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard deviation found in the respective testing measurements. Also, as used herein, the term “the same” generally means within 10%, 5%, 1%, or 0.5% of a given value or range. Alternatively, the term “the same” means within an acceptable standard error of the mean when considered by one of ordinary skill in the art. As could be appreciated, other than in the operating/working examples, or unless otherwise expressly specified, all of the numerical ranges, amounts, values, and percentages (such as those for quantities of materials, duration of times, temperatures, operating conditions, portions of amounts, and the likes) disclosed herein should be understood as modified in all instances by the term “the same.” Accordingly, unless indicated to the contrary, the numerical parameters set forth in the present disclosure and attached claims are approximations that can vary as desired. At the very least, each numerical parameter should at least be construed in light of the number of reported significant digits and by applying ordinary rounding techniques. Here, ranges can be expressed as from one endpoint to another endpoint or between two endpoints. All ranges disclosed herein are inclusive of the endpoints, unless specified otherwise.

Generally speaking, when a GPU dispatches a warp to a streaming processor (SP), it will allocate the same size of register space of the SP to each warp, and this space will be occupied until the warp is executed by the SP. However, since different warps may represent different functions, the actual register space required by each warp may be different. To allocate the same register space to all warps equally, it is necessary to accommodate the warp that requires the most register space to determine the size of this space, resulting in low efficiency in register allocation and making register space a bottleneck in the number of warps that can be scheduled to the SP.

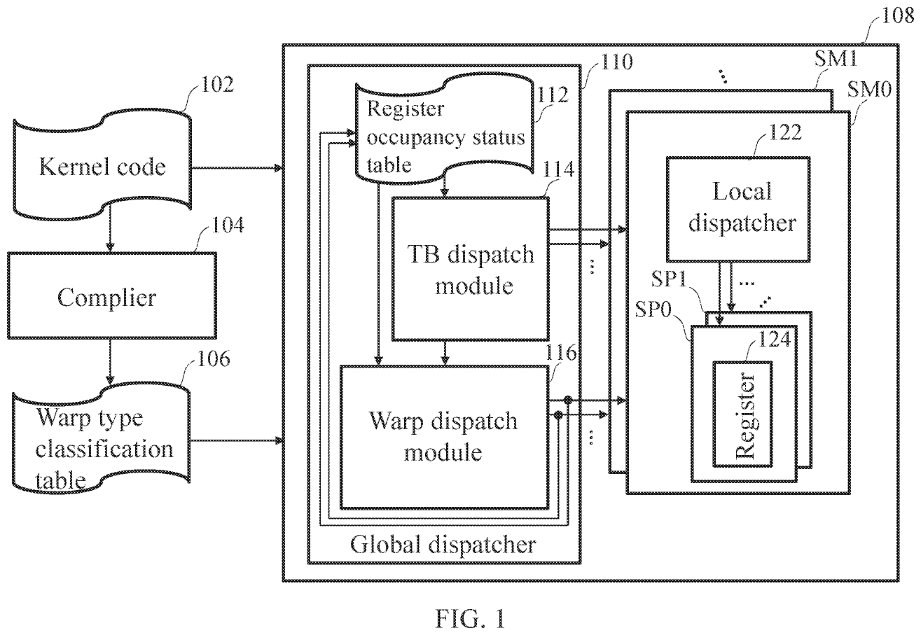

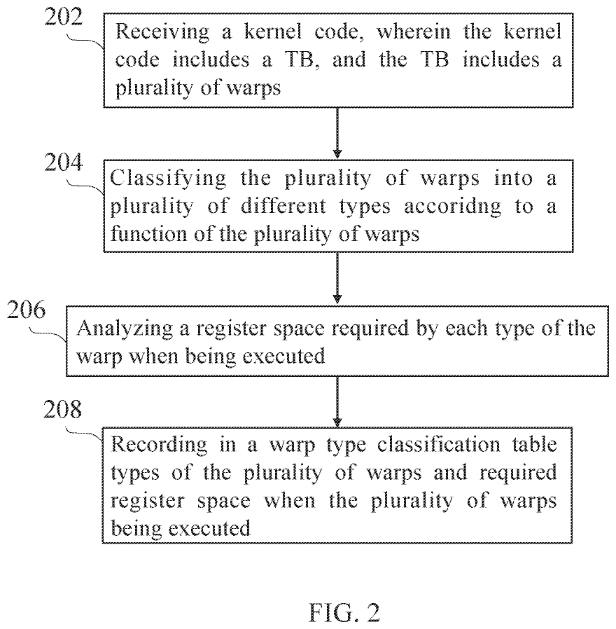

FIG. 1 is a schematic diagram illustrating a GPU according to embodiments of the present disclosure. The GPU 108 is configured to execute a kernel code 102. The kernel code 102 can include one or more tread blocks (TBs), wherein each TB includes a plurality of warps, for the ease of discussion, one tread block (TB0) of the TB of the kernel code 102 is used as an example for illustration. FIG. 2 is a flowchart illustrating a method performed by a complier according to embodiments of the present disclosure. In Step 202, the complier 104 is used to receive the kernel code 102, and in Step 204, a plurality of warps W0˜W14 of the tread block TB0 are classified into a plurality of different types. For example, the complier 104 can can perform static code analysis on the kernel code 102, and during the process of analysis, it will classify the plurality of warps W0˜W14 according to their functions, for example, some warps will cause the GPU 108 to perform “computing” actions when executed by the GPU 108, so these warps are classified as computation type warps; while some warps will cause the GPU 108 to perform “load/store” actions when executed by the GPU 108, so these warps are classified as memory type warps.

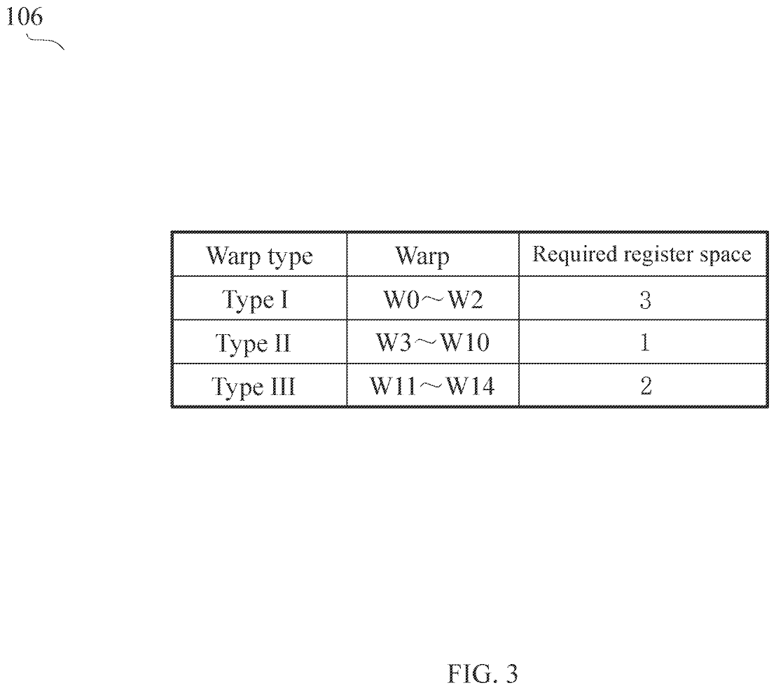

Then in Step 206, the complier 104 further analyze the maximum register space required when each type of warps are executed by the SP; for example, for computation type warps, the complier 104 determines that a maximum of 192 bytes is required; whereas for memory type warps, the complier 104 determines that only a maximum of 64 bytes is required. In Step 208, the complier 104 will record the type of the plurality of warps W0˜W14 and the register space required when the warps are executed in the warp type classification table 106. FIG. 3 is a schematic diagram illustrating a warp type classification table 106 of FIG. 1 according to embodiments of the present disclosure. As could be seen in FIG. 3, the warps W0˜W2 are classified as the type I, which requires 3 units of register space; the warps W3˜W10 are classified as the type II, which requires 1 unit of register space; the warps W11˜W14 are classified as the type III, which requires 2 units of register space. In the present disclosure, 1 unit of register space can be any length of bytes, for example, 64 bytes, and the number of the type of warps is not limited to three.

The warp type classification table 106 will be sent to the GPU 108, so that the GPU 108 can dispatch the plurality of warps W0˜W14 of the tread block TB0 according to the warp type classification table 106. More specifically, in certain embodiments, the warp type classification table 106 will be added to a kernel launch command, when the GPU 108 receives the kernel launch command, it will also receives the warp type classification table 106 at the same time.

As discussed above, the GPU 108 will read the kernel code 102 from a global memory outside of the GPU 108 according to the kernel launch command to obtain the tread block TB0, and the global dispatcher 110 of the GPU 108 dispatches the tread block TB0 to one of a plurality of streaming multiprocessors (SM) SM0, SM1, . . . (for example, to the streaming multiprocessor SM0) according to the warp type classification table 106; and dispatches the tread block TB0 of the plurality of warps W0˜W14 of the tread block TB0 to the plurality of streaming processors SP0, SP1, . . . of the streaming multiprocessor SM0. The local dispatcher 122 of the streaming multiprocessor SM0 then allocates the plurality of warps W0˜W14 to the register 124 of the plurality of streaming processors SP0, SP1, . . . according to the dispatch of the global dispatcher 110.

Each of the plurality of streaming multiprocessors SM0, SM1, . . . has the plurality of streaming processors SP0, SP1, . . . , whereas each of the SPs has a register 124. Each SP of each SM has a predetermined upper bound of warp number, i.e., the number of warps can be dispatched to each SP of each SM is limited to the predetermined upper bound of warp number; further, the register 124 of each SP of each SM has a predetermined upper bound of register capacity. In the present embodiment, the predetermined upper bound of warp number of each SP of each SM is the same, and the predetermined upper bound of register capacity of the register 124 of each SP of each SM is the same; however, the present disclosure is not limited thereto.

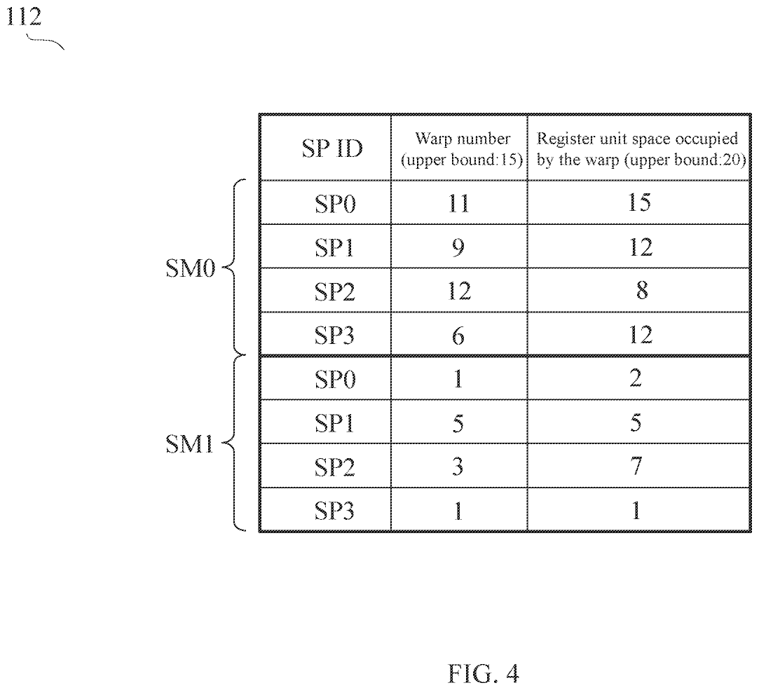

Specifically, the global dispatcher 110 includes a register occupancy status table 112, a TB dispatch module 114 and a warp dispatch module 116. The register occupancy status table 112 is configured to record the warp number already dispatched to each SP of each SM and the occupancy status of the register. FIG. 4 is a schematic diagram illustrating the register occupancy status table 112 of FIG. 1 according to embodiments of the present disclosure. In the present embodiment, it is assume that each SM only has four streaming processors SP0˜SP3, and hence, the current warp number of the streaming processor SP0˜SP3 of each of the streaming multiprocessors SM0˜SM1 of the GPU 108 and the occupancy status of the register are shown in the register occupancy status table 112. For the sake of brevity, in the present embodiment, it is assumed that the GPU 108 has only two streaming multiprocessors SM0˜SM1; further, in the present embodiment, it is assumed that the predetermined upper bound of warp number is 15, and the predetermined upper bound of register capacity is 20 units of space.

The TB dispatch module 114 will obtain the remaining available register space of each of the streaming multiprocessor SM0˜SM1 according to the register occupancy status table 112 and the predetermined upper bound of register capacity. As could be seen in the embodiment of FIG. 4, 15 units of space in the register 124 of the streaming processor SP0 of the streaming multiprocessor SM0 has been occupied, and therefore, the available space left is 5 (20-15) units of space. Hence, there are a total of 33 units of space left in the streaming processor SP0˜SP3 of the streaming multiprocessor SM0; that is, the remaining available register space of the streaming multiprocessor SM0 is 33 units of space in total, whereas the remaining available register space of the streaming multiprocessor SM1 is 65 units of space in total.

The TB dispatch module 114 further obtains the remaining number of acceptable warps of each of the streaming multiprocessor SM0˜SM1 according to the register occupancy status table 112 and the predetermined upper bound of warp number. As could be seen in the embodiment of FIG. 4, 11 warps have already been dispatched to the streaming processor SP0 of the streaming multiprocessor SM0 and have not been executed completely, therefore, there are 4 (15-11) remaining number of acceptable warps left. Hence, there are a total of 22 remaining number of acceptable warps left in the streaming processor SP0˜SP3 of the streaming multiprocessor SM0; that is, the remaining number of acceptable warps of the streaming multiprocessor SM0 is 22 in total, whereas the remaining number of acceptable warps of the streaming multiprocessor SM1 is 50 in total.

the TB dispatch module 114 further calculates the sum of the required register space and the sum of the number of the warps of the tread block TB0 according to the warp type classification table 106. As could be seen in the embodiment of FIG. 3, in the tread block TB0, there are three type I warps (W0˜W2), and hence, the sum of the required register space is 9 units of space (i.e., 3*3 units of space); there are eight type II warps (W3˜W10), and hence, the sum of the required register space is 8 units of space (i.e., 8*1 units of space); there are five type III warps 5 (W11˜W14), and hence, the sum of the required register space is 10 units of space (i.e., 5*2 units of space). In this way, it can be determined that the sum of the required register space of the tread block TB0 is 27 units of space (i.e., 9+8+10 units of space), whereas the sum of the required register space of the tread block TB0 is 15 (i.e., the number of W0˜W14).

In this way, the TB dispatch module 114 can determine whether any SM of the plurality of SMs SM0˜SM1 meets a first condition according to the sum of the required register space of the tread block TB0, the sum of the number of the warps of the tread block TB0, and the remaining available register space and the remaining number of acceptable warps of each of the plurality of SMs SM0˜SM1. For an SM to meet the above-mentioned first condition, its remaining available register space cannot be less than the sum of the required register space of the tread block TB0, and its remaining number of acceptable warps cannot be less than the sum of the number of the warps of the thread block TB0. As could be seen in the embodiments of FIG. 3 and FIG. 4, the remaining available register space of the streaming multiprocessor SM0 has a total of 33 units of space, which is no less than the sum of the required register space of the tread block TB0 (27 units of space), and the remaining number of acceptable warps of the streaming multiprocessor SM0 (22) is also no less than the sum of the number of the warps of the tread block TB0 (15); hence, the streaming multiprocessor SM0 meets the first condition; the remaining available register space of the streaming multiprocessor SM1 has a total of 65 units of space, which is no less than the sum of the required register space of the tread block TB0 (27 units of space), and the remaining number of acceptable warps of the streaming multiprocessor SM1 (50) is also no less than the sum of the number of the warps of the tread block TB0 (15); hence, the streaming multiprocessor SM1 also meets the first condition.

The TB dispatch module 114 further determine whether any SM of the plurality of SMs SM0˜SM1 meets a second condition according to the number of type I warps in the warp type classification table 106, the units of register space required when the type I warp is executed, and the register occupancy status table 112. Details of the second condition are discussed below.

For the streaming multiprocessor SM0, it can be known from the register occupancy status table 112 that the remaining number of acceptable warps of the streaming processor SP0 is 4, and the register of the streaming processor SP0 has 5 units of space available. Therefore, from the perspective of the remaining number of acceptable warps, the streaming processor SP0 can further can accepts 4 type I warp; whereas from the perspective of the register space, the streaming processor SP0 can only accept 1 type I warp (because the type I warp requires 3 units of register space). So, comprehensively, at most 1 type I warp can be dispatched to the streaming processor SP0. Hence, at most 2 type I warps can be dispatched to the streaming processor SP1; at most 3 type I warps can be dispatched to the streaming processor SP2; and at most 2 type I warps can be dispatched to the streaming processor SP3. Finally, it can be seen from the above that for the streaming multiprocessor SM0, it can further accept 8 (i.e., 1+2+3+2) type I warps at most. Since the number of type I warps that the streaming multiprocessor SM0 can accept at most (i.e., 8) is greater than the number of the type I warps of the tread block TB0 recorded in the warp type classification table 106 (i.e., 3), the streaming multiprocessor SM0 meets the second condition.

The TB dispatch module 114 further determine whether any SM of the plurality of SMs SM0˜SM1 meets a third condition according to the number of type II warps in the warp type classification table 106, the units of register space required when the type II warp is executed, and the register occupancy status table 112. Details of the third condition are discussed below.

For the streaming multiprocessor SM0, it can be known from the register occupancy status table 112 that the remaining number of acceptable warps of the streaming processor SP0 is 4, and the register of the streaming processor SP0 has 5 units of space available. Therefore, from the perspective of the remaining number of acceptable warps, the streaming processor SP0 can further can accepts 4 type I warp; whereas from the perspective of the register space, the streaming processor SP0 can only accept 5 type II warps (because the type II warp requires 1 unit of register space). So, comprehensively, at most 4 type II warps can be dispatched to the streaming processor SP0. Hence, at most 6 type II warps can be dispatched to the streaming processor SP1; at most 3 type II warps can be dispatched to the streaming processor SP2; and at most 8 type II warps can be dispatched to the streaming processor SP3. Finally, it can be seen from the above that for the streaming multiprocessor SM0, it can further accept 21 (i.e., 4+6+3+8) type II warps at most. Since the number of type II warps that the streaming multiprocessor SM0 can accept at most (i.e., 21) is greater than the number of the type II warps of the tread block TB0 recorded in the warp type classification table 106 (i.e., 8), the streaming multiprocessor SM0 meets the third condition.

The TB dispatch module 114 further determine whether any SM of the plurality of SMs SM0˜SM1 meets a fourth condition according to the number of type III warps in the warp type classification table 106, the units of register space required when the type III warp is executed, and the register occupancy status table 112. Details of the fourth condition are discussed below.

For the streaming multiprocessor SM0, it can be known from the register occupancy status table 112 that the remaining number of acceptable warps of the streaming processor SP0 is 4, and the register of the streaming processor SP0 has 5 units of space available. Therefore, from the perspective of the remaining number of acceptable warps, the streaming processor SP0 can further can accepts 4 type III warps; whereas from the perspective of the register space, the streaming processor SP0 can only accept 2 type III warps (because the type III warp requires 2 units of register space). So, comprehensively, at most 2 type III warps can be dispatched to the streaming processor SP0. Hence, at most 4 type III warps can be dispatched to the streaming processor SP1; at most 3 type III warps can be dispatched to the streaming processor SP2; and at most 4 type III warps can be dispatched to the streaming processor SP3. Finally, it can be seen from the above that for the streaming multiprocessor SM0, it can further accept 13 (i.e., 2+4+3+4) type III warps at most. Since the number of type III warps that the streaming multiprocessor SM0 can accept at most (i.e., 13) is greater than the number of the type III warps of the tread block TB0 recorded in the warp type classification table 106 (i.e., 5), the streaming multiprocessor SM0 meets the third fourth. Approaches for determining whether the streaming multiprocessor SM1 meets the second condition, third condition and the fourth condition are similar, and hence is not repeated below for the sake of brevity.

In the present embodiment, the TB dispatch module 114 according to round-robin scheduling, sequentially determines whether the streaming multiprocessor SM0 meets the first condition, the second condition, the third condition and the fourth condition, if all conditions are met, then the TB dispatch module 114 can directly dispatch the tread block TB0 to the streaming multiprocessor SM0. If the streaming multiprocessor SM0 does not meet all of the first condition, the second condition, the third condition and the fourth condition, then the TB dispatch module 114 continues to determine whether the streaming multiprocessor SM1 meets the first condition, the second condition, the third condition and the fourth condition, until it finds a streaming multiprocessor meets all of the first condition, the second condition, the third condition and the fourth condition or all the streaming multiprocessor has been checked. In certain embodiments, it is also feasible to find all the streaming multiprocessors that meets the first condition, the second condition, the third condition and the fourth condition, and then chose the appropriate streaming multiprocessor among them to accept the tread block TB0.

Assuming that the TB dispatch module 114 determines to dispatch the tread block TB0 to the streaming multiprocessor SM0, then it will notify the streaming multiprocessor SM0 and the warp dispatch module 116. The warp dispatch module 116 will dispatch the warps W0˜W14 of the tread block TB0 to the streaming processor SP0˜SP3 of the streaming multiprocessor SM0 according to the warp type classification table 106 and the register occupancy status table 112. Specifically, the warp dispatch module 116 can use the round-robin scheduling, and dispatch the warps W0˜W14 to the streaming processor SP0˜SP3 of the streaming multiprocessor SM0 according to the warp type classification table 106 and the remaining available register space and the remaining number of acceptable warps of each of the SPs SP0˜SP3 of the streaming multiprocessor SM0.

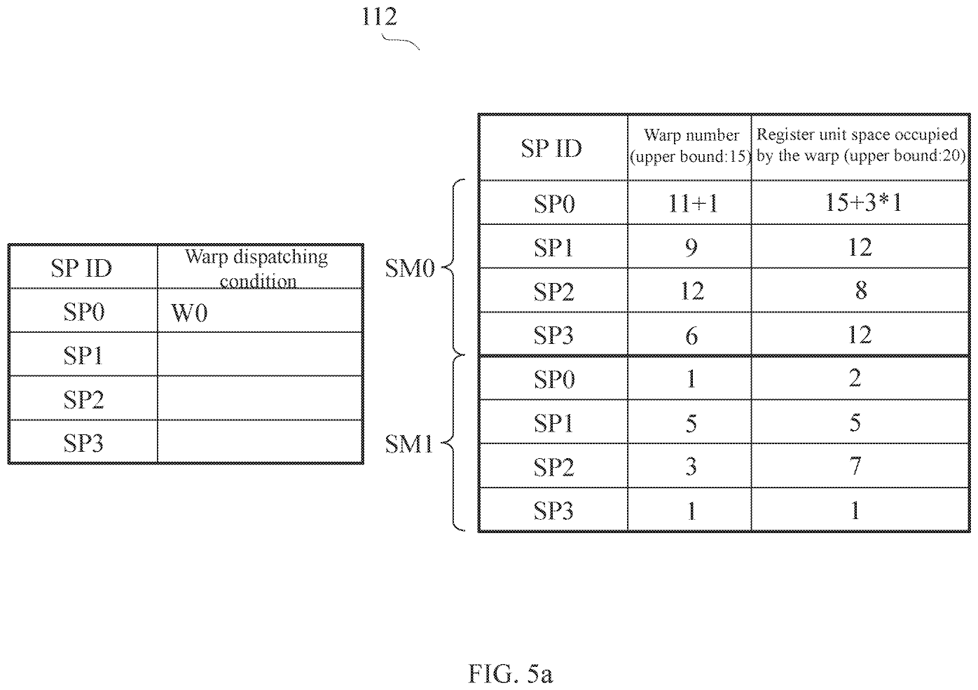

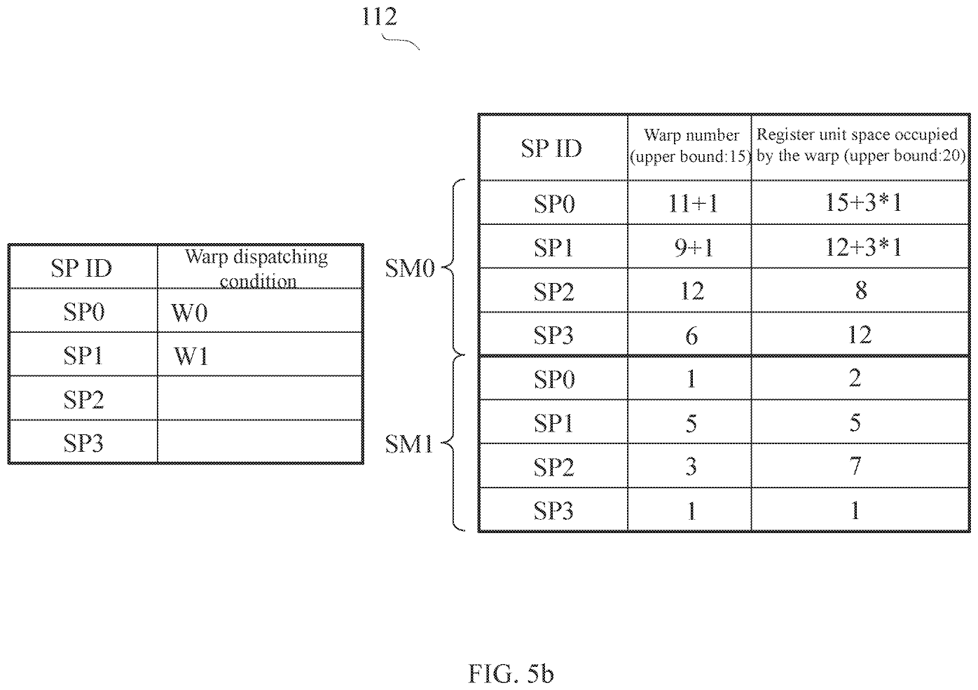

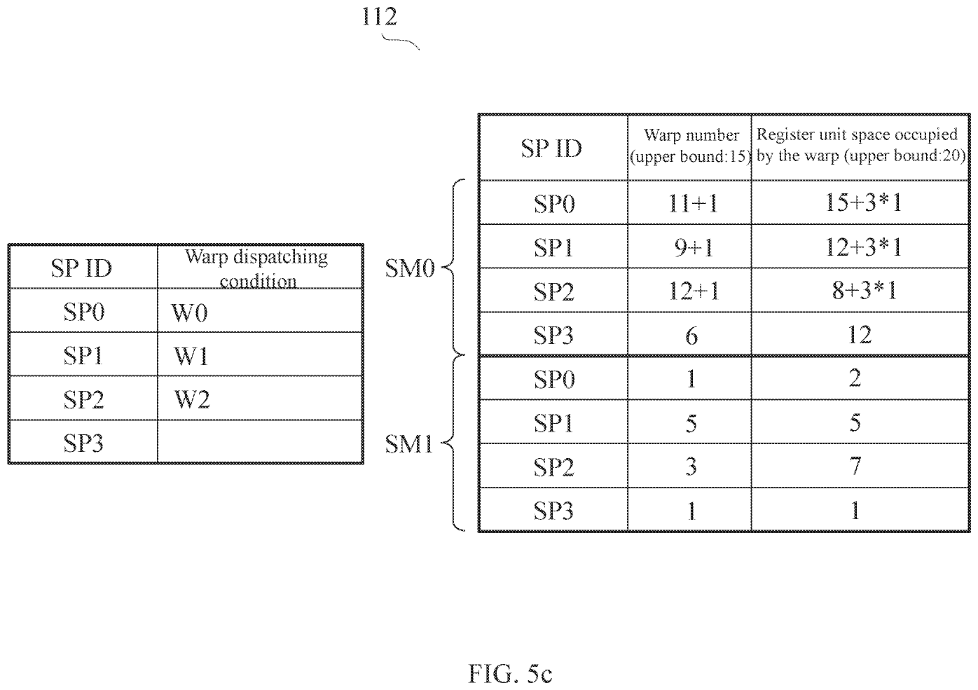

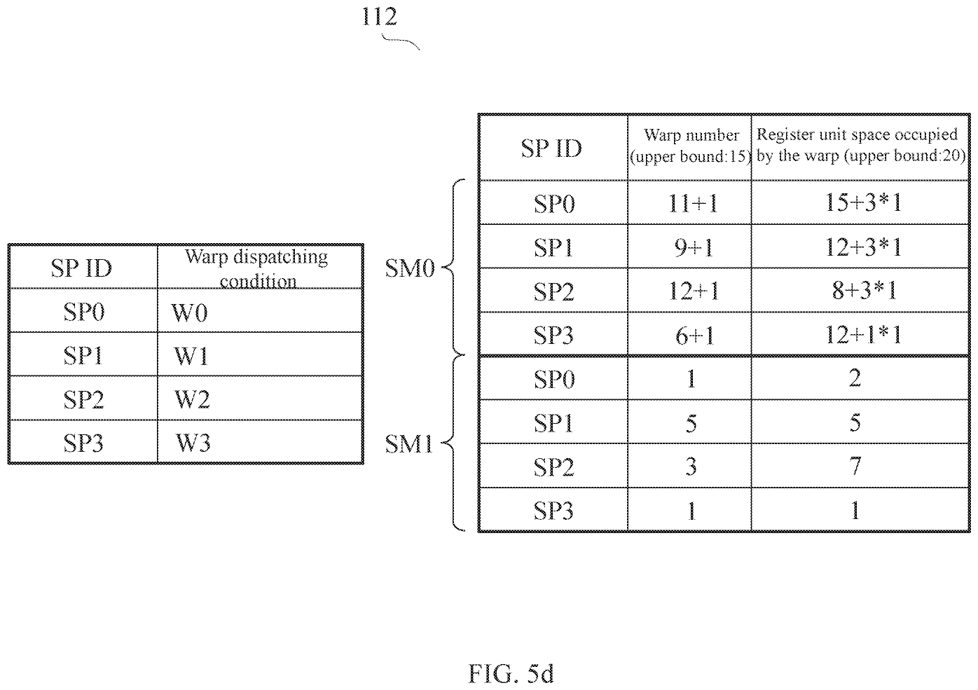

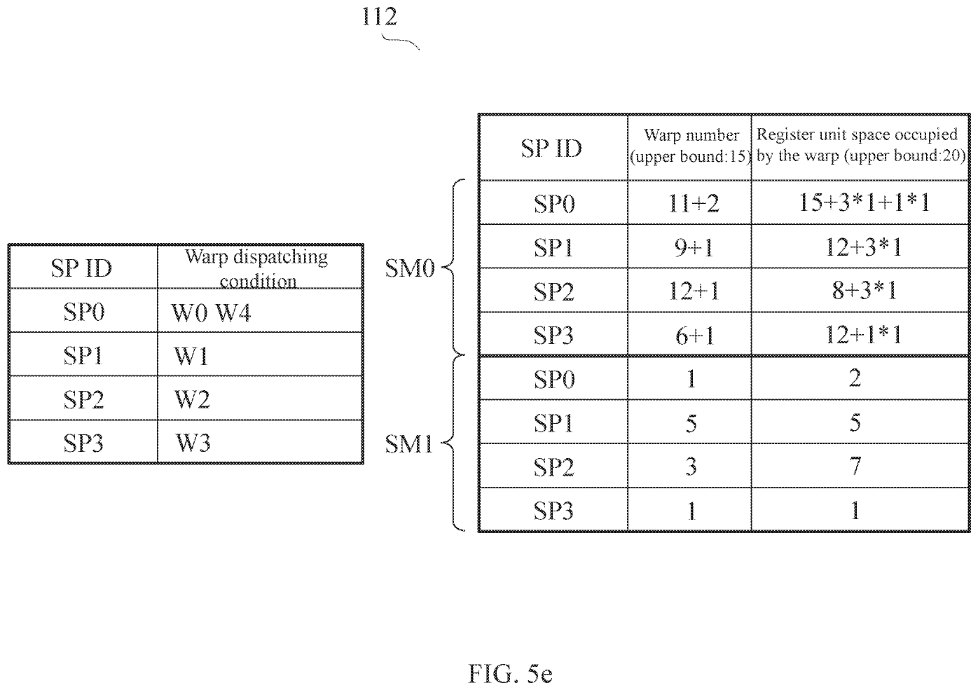

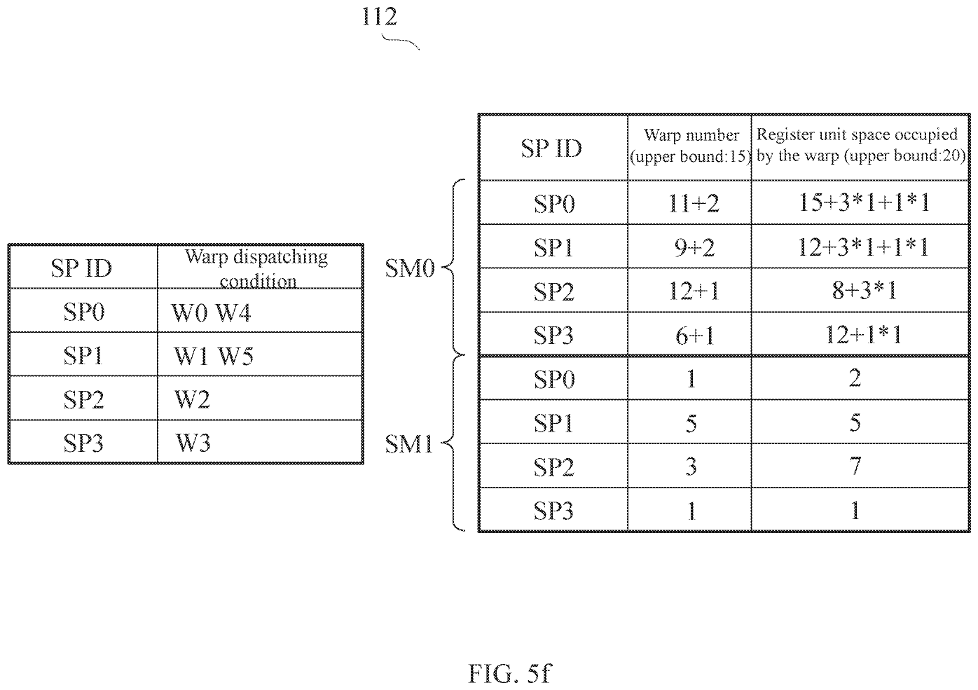

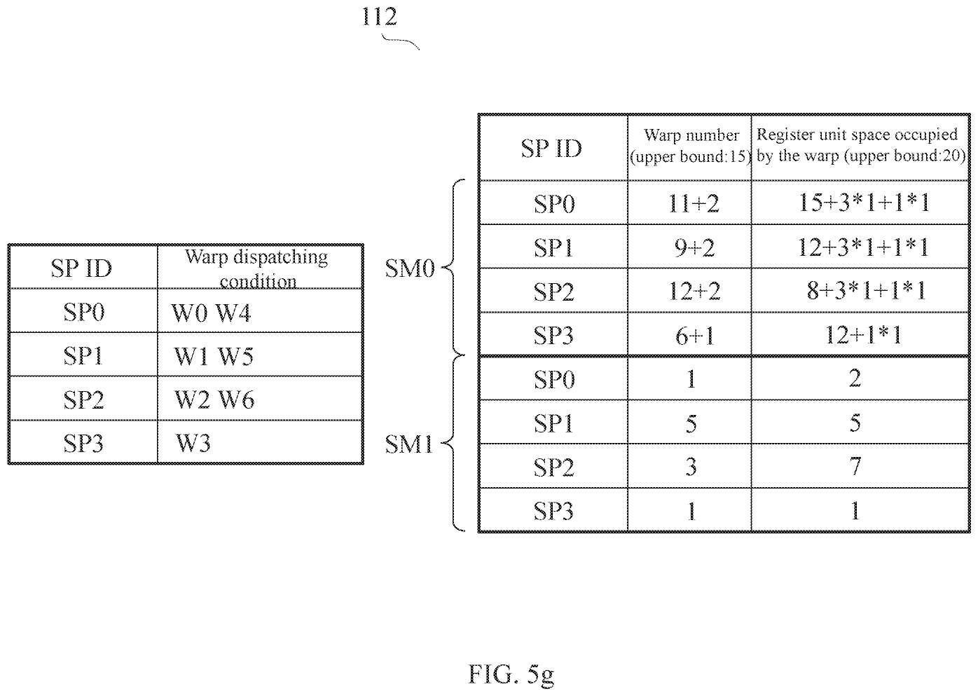

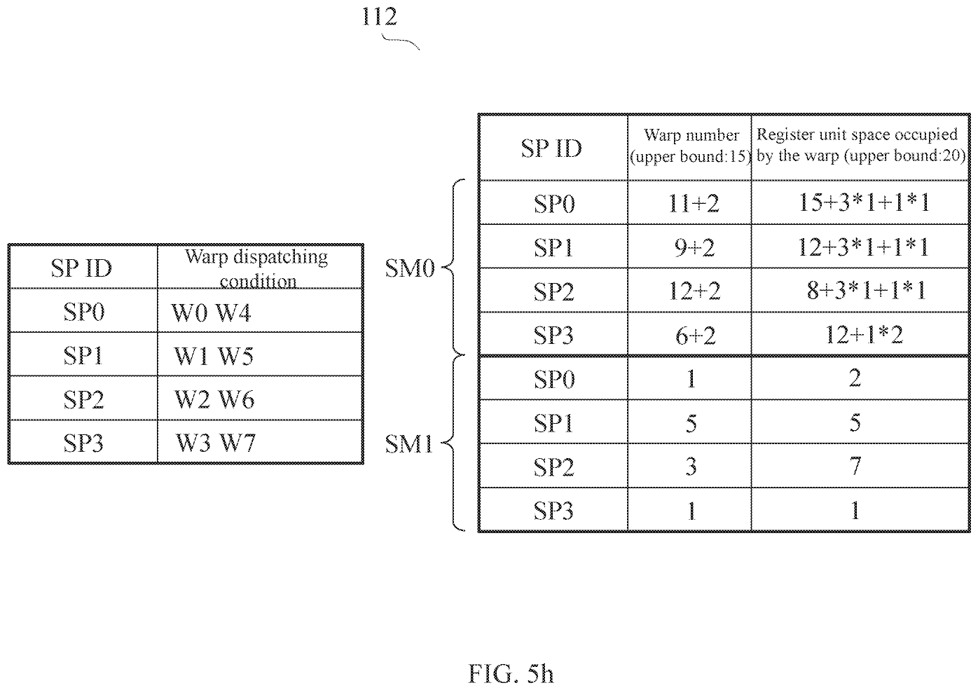

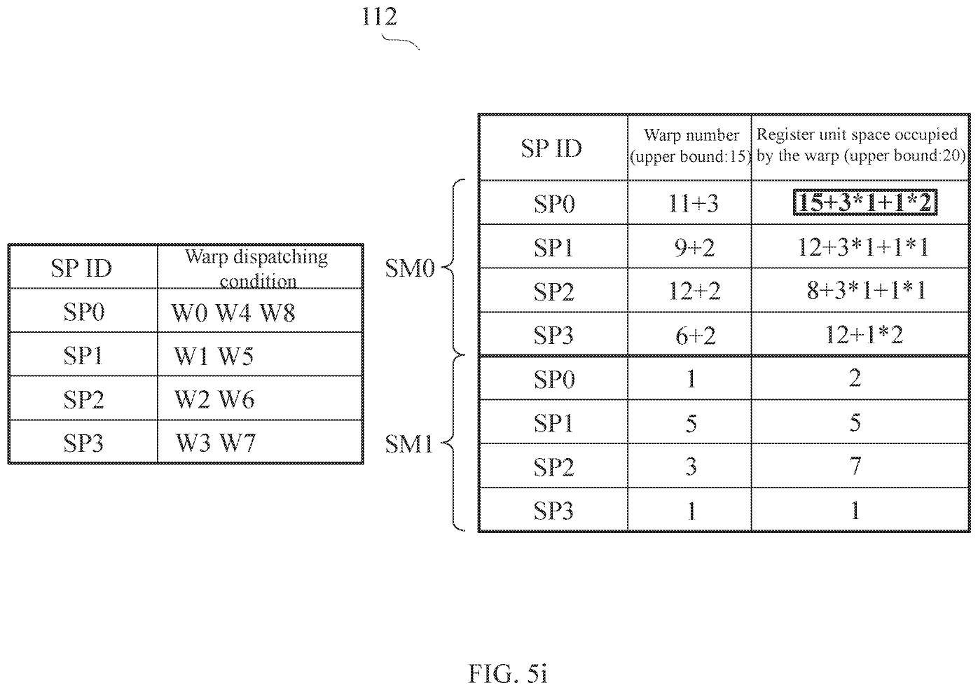

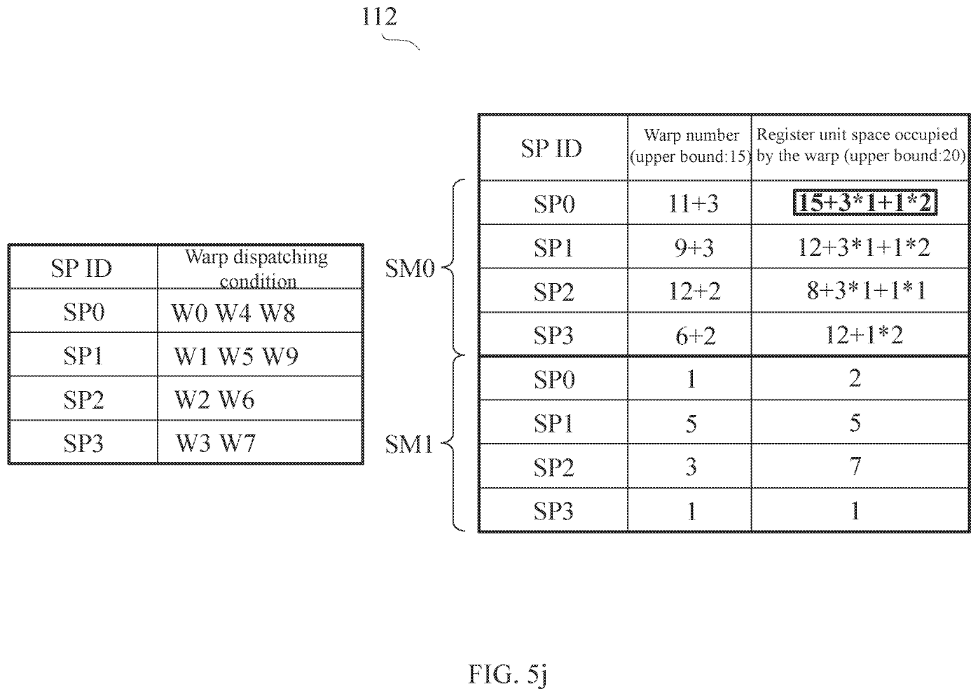

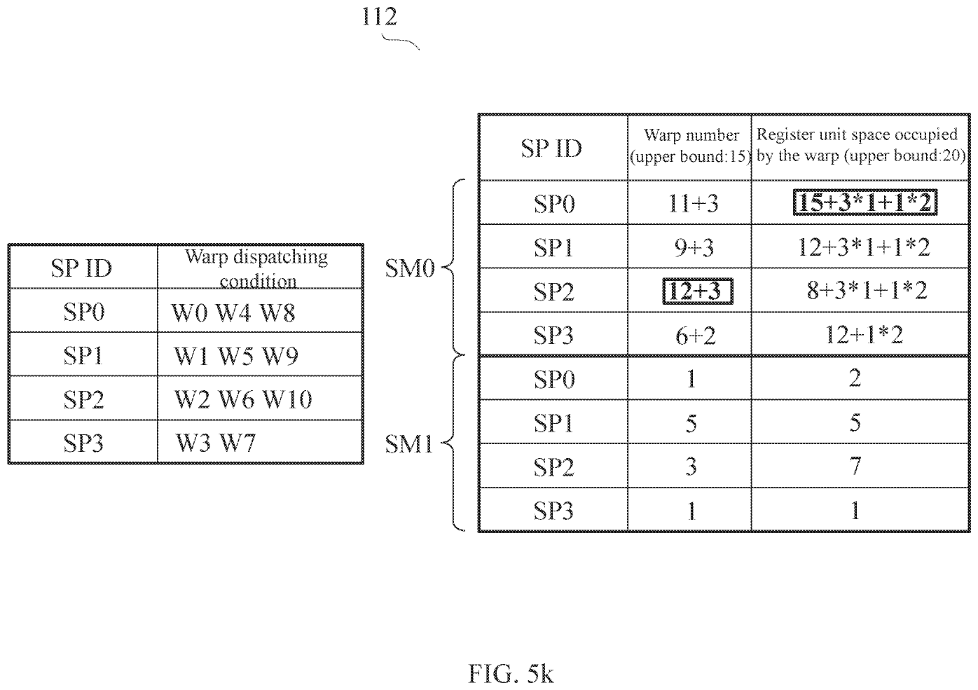

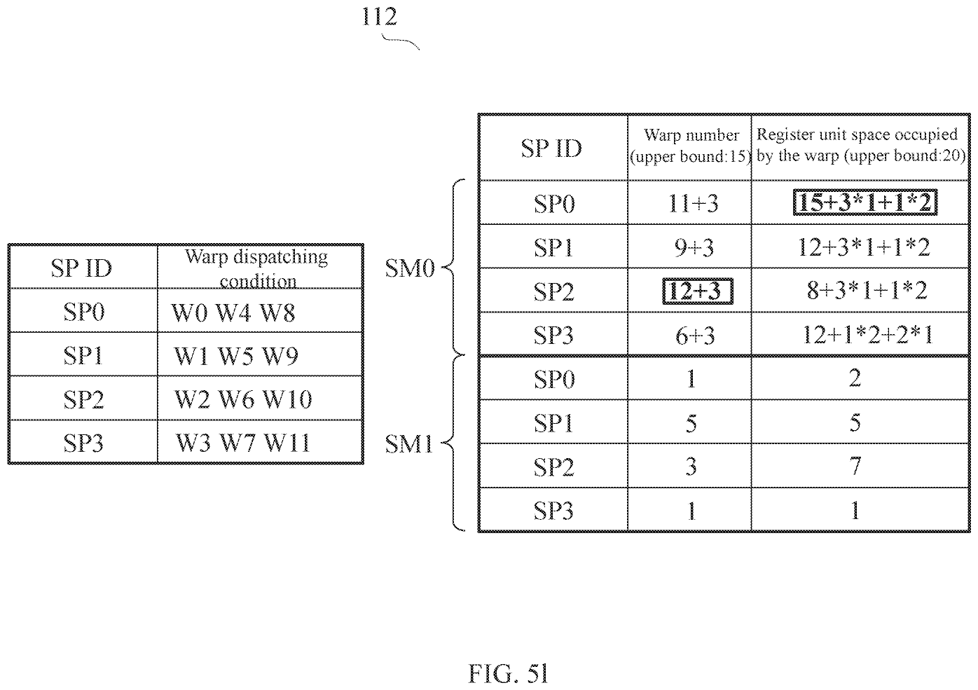

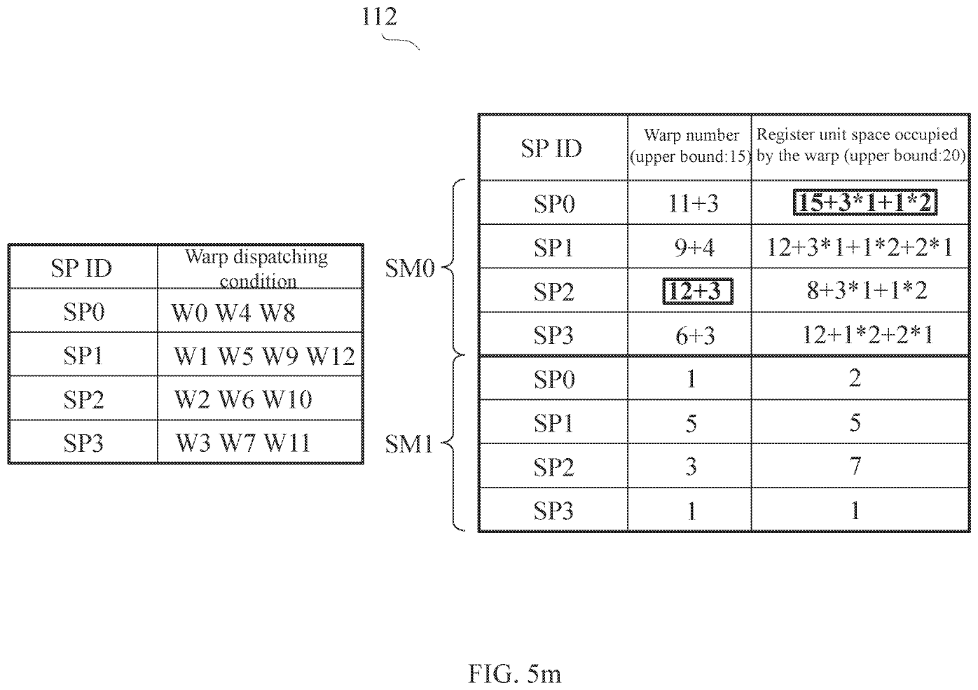

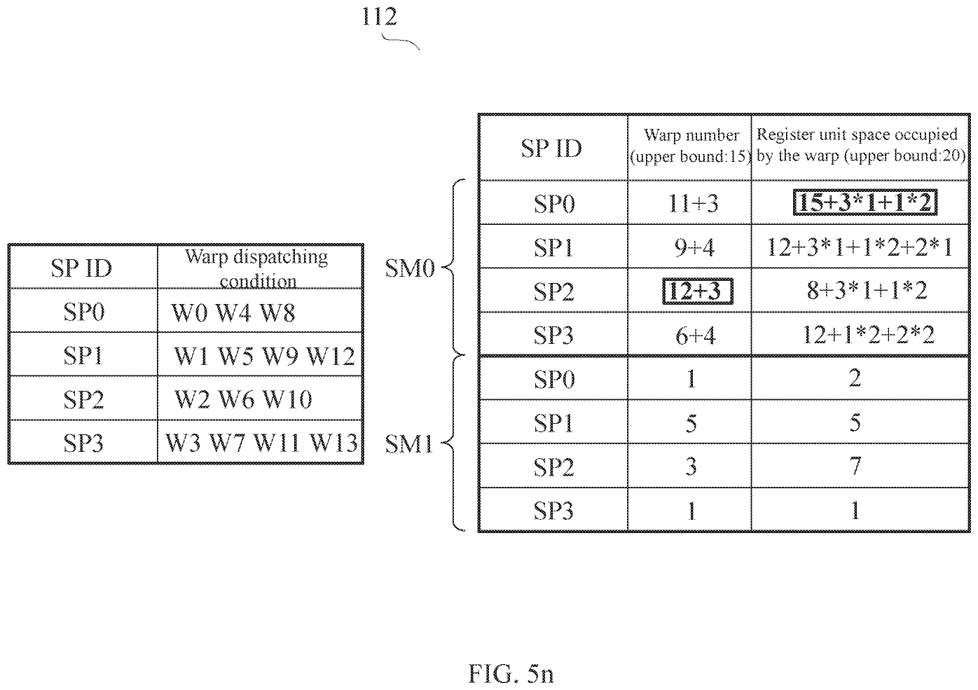

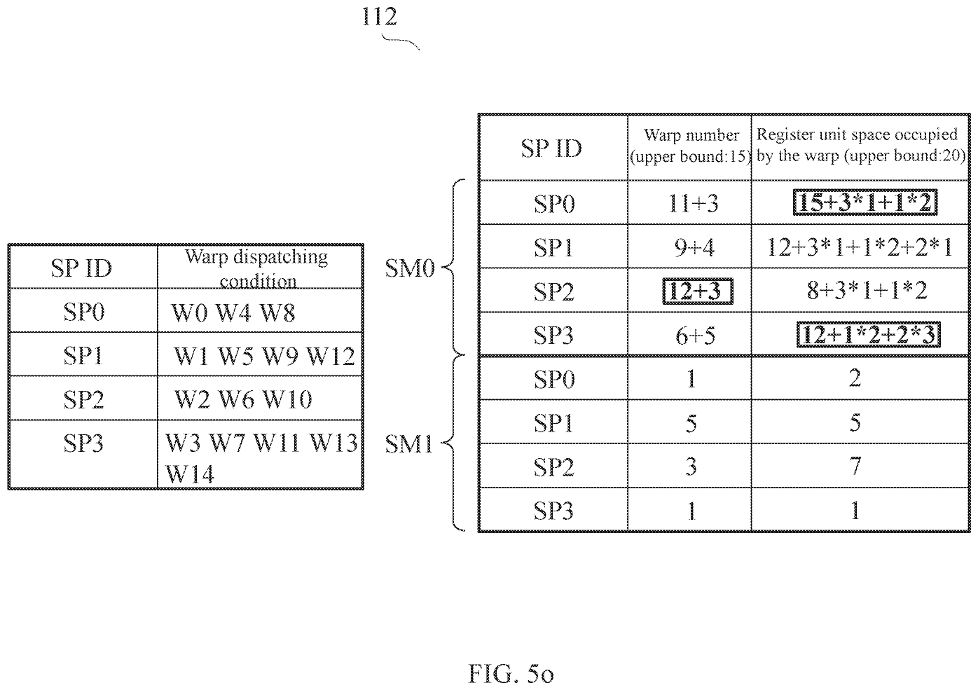

FIG. 5a to FIG. 5o are schematic diagrams illustrating the warp dispatch module 116 dispatching a plurality of warps W0˜W14 of the tread block TB0 to the streaming processor SP0˜SP3 of the streaming multiprocessor SM0 according to embodiments of the present disclosure. In FIG. 5a to FIG. 5o, the table at the left illustrates the most recent dispatching condition of the warps W0˜W14, whereas the table at the right is the register occupancy status table 112. It should be noted that the warp dispatch module 116 will update the register occupancy status table 112 in real-time according to the dispatching result of the warps W0˜W14. It should be noted that, in the examples of FIG. 5a to FIG. 5o, the round-robin scheduling is used to sequentially dispatch the warp to the available SP; however, the present disclosure is not limited thereto, and approaches other than the round-robin scheduling can be used.

In FIG. 5a, the warp dispatch module 116 determines, according to the warp type classification table 106 and the register occupancy status table 112, that dispatching the warp W0 to the streaming processor SP0 in the streaming multiprocessor SM0 will not exceed the predetermined upper bound of warp number and the predetermined upper bound of register capacity; thus, the warp dispatch module 116 dispatches the warp W0 to the streaming processor SP0 in the streaming multiprocessor SM0 and updates the number of warps of the streaming processor SP0 in the streaming multiprocessor SM0 to 12 (i.e., 11+1) and the register unit space occupied by the warp to 18 (i.e., 15+3*1) in the register occupancy status table 112.

In FIG. 5b, the warp dispatch module 116 determines, according to the warp type classification table 106 and the register occupancy status table 112, that dispatching the warp W1 to the streaming processor SP1 in the streaming multiprocessor SM0 will not exceed the predetermined upper bound of warp number and the predetermined upper bound of register capacity; thus, the warp dispatch module 116 dispatches the warp W1 to the streaming processor SP1 in the streaming multiprocessor SM0 and updates the number of warps of the streaming processor SP1 in the streaming multiprocessor SM0 to 10 (i.e., 9+1) and the register unit space occupied by the warp to 15 (i.e., 12+3*1) in the register occupancy status table 112.

In FIG. 5c, the warp dispatch module 116 determines, according to the warp type classification table 106 and the register occupancy status table 112, that dispatching the warp W2 to the streaming processor SP2 in the streaming multiprocessor SM0 will not exceed the predetermined upper bound of warp number and the predetermined upper bound of register capacity; thus, the warp dispatch module 116 dispatches the warp W2 to the streaming processor SP2 in the streaming multiprocessor SM0 and updates the number of warps of the streaming processor SP2 in the streaming multiprocessor SM0 to 13 (i.e., 12+1) and the register unit space occupied by the warp to 11 (i.e., 8+3*1) in the register occupancy status table 112.

In FIG. 5d, the warp dispatch module 116 determines, according to the warp type classification table 106 and the register occupancy status table 112, that dispatching the warp W3 to the streaming processor SP3 in the streaming multiprocessor SM0 will not exceed the predetermined upper bound of warp number and the predetermined upper bound of register capacity; thus, the warp dispatch module 116 dispatches the warp W3 to the streaming processor SP3 in the streaming multiprocessor SM0 and updates the number of warps of the streaming processor SP3 in the streaming multiprocessor SM0 to 7 (i.e., 6+1) and the register unit space occupied by the warp to 13 (i.e., 12+1*1) in the register occupancy status table 112.

In FIG. 5e, the warp dispatch module 116 determines, according to the warp type classification table 106 and the register occupancy status table 112, that dispatching the warp W4 to the streaming processor SP0 in the streaming multiprocessor SM0 will not exceed the predetermined upper bound of warp number and the predetermined upper bound of register capacity; thus, the warp dispatch module 116 dispatches the warp W4 to the streaming processor SP0 in the streaming multiprocessor SM0 and updates the number of warps of the streaming processor SP0 in the streaming multiprocessor SM0 to 13 (i.e., 11+2) and the register unit space occupied by the warp to 19 (i.e., 15+3*1+1*1) in the register occupancy status table 112.

In FIG. 5f, the warp dispatch module 116 determines, according to the warp type classification table 106 and the register occupancy status table 112, that dispatching the warp W5 to the streaming processor SP1 in the streaming multiprocessor SM0 will not exceed the predetermined upper bound of warp number and the predetermined upper bound of register capacity; thus, the warp dispatch module 116 dispatches the warp W5 to the streaming processor SP1 in the streaming multiprocessor SM0 and updates the number of warps of the streaming processor SP1 in the streaming multiprocessor SM0 to 11 (i.e., 9+2) and the register unit space occupied by the warp to 16 (i.e., 12+3*1+1*1) in the register occupancy status table 112.

In FIG. 5g, the warp dispatch module 116 determines, according to the warp type classification table 106 and the register occupancy status table 112, that dispatching the warp W6 to the streaming processor SP2 in the streaming multiprocessor SM0 will not exceed the predetermined upper bound of warp number and the predetermined upper bound of register capacity; thus, the warp dispatch module 116 dispatches the warp W6 to the streaming processor SP2 in the streaming multiprocessor SM0 and updates the number of warps of the streaming processor SP2 in the streaming multiprocessor SM0 to 14 (i.e., 12+2) and the register unit space occupied by the warp to 12 (i.e., 8+3*1+1*1) in the register occupancy status table 112.

In FIG. 5h, the warp dispatch module 116 determines, according to the warp type classification table 106 and the register occupancy status table 112, that dispatching the warp W7 to the streaming processor SP3 in the streaming multiprocessor SM0 will not exceed the predetermined upper bound of warp number and the predetermined upper bound of register capacity; thus, the warp dispatch module 116 dispatches the warp W7 to the streaming processor SP3 in the streaming multiprocessor SM0 and updates the number of warps of the streaming processor SP3 in the streaming multiprocessor SM0 to 8 (i.e., 6+2) and the register unit space occupied by the warp to 14 (i.e., 12+1*2) in the register occupancy status table 112.

In FIG. 5i, the warp dispatch module 116 determines, according to the warp type classification table 106 and the register occupancy status table 112, that dispatching the warp W8 to the streaming processor SP0 in the streaming multiprocessor SM0 will not exceed the predetermined upper bound of warp number and the predetermined upper bound of register capacity; thus, the warp dispatch module 116 dispatches the warp W8 to the streaming processor SP0 in the streaming multiprocessor SM0 and updates the number of warps of the streaming processor SP0 in the streaming multiprocessor SM0 to 14 (i.e., 11+3) and the register unit space occupied by the warp to 20 (i.e., 15+3*1+1*2) in the register occupancy status table 112. It should be noted that the updated register occupancy status table 112 shows that the register space unit occupied by the warps of the streaming processor SP0 of the streaming multiprocessor SM0 has reached the predetermined upper bound of register capacity.

In FIG. 5j, the warp dispatch module 116 determines, according to the warp type classification table 106 and the register occupancy status table 112, that dispatching the warp W9 to the streaming processor SP1 in the streaming multiprocessor SM0 will not exceed the predetermined upper bound of warp number and the predetermined upper bound of register capacity; thus, the warp dispatch module 116 dispatches the warp W9 to the streaming processor SP1 in the streaming multiprocessor SM0 and updates the number of warps of the streaming processor SP1 in the streaming multiprocessor SM0 to 12 (i.e., 9+3) and the register unit space occupied by the warp to 17 (i.e., 12+3*1+1*2) in the register occupancy status table 112.

In FIG. 5k, the warp dispatch module 116 determines, according to the warp type classification table 106 and the register occupancy status table 112, that dispatching the warp W10 to the streaming processor SP2 in the streaming multiprocessor SM0 will not exceed the predetermined upper bound of warp number and the predetermined upper bound of register capacity; thus, the warp dispatch module 116 dispatches the warp W10 to the streaming processor SP2 in the streaming multiprocessor SM0 and updates the number of warps of the streaming processor SP2 in the streaming multiprocessor SM0 to 15 (i.e., 12+3) and the register unit space occupied by the warp to 13 (i.e., 8+3*1+1*2) in the register occupancy status table 112. It should be noted that the updated register occupancy status table 112 shows that number of warps in the streaming processor SP2 of the streaming multiprocessor SM0 has reached the predetermined upper bound of warp number.

In FIG. 5l, the warp dispatch module 116 determines, according to the warp type classification table 106 and the register occupancy status table 112, that dispatching the warp W11 to the streaming processor SP3 in the streaming multiprocessor SM0 will not exceed the predetermined upper bound of warp number and the predetermined upper bound of register capacity; thus, the warp dispatch module 116 dispatches the warp W11 to the streaming processor SP3 in the streaming multiprocessor SM0 and updates the number of warps of the streaming processor SP3 in the streaming multiprocessor SM0 to 9 (i.e., 6+3) and the register unit space occupied by the warp to 16 (i.e., 12+1*2+2*1) in the register occupancy status table 112.

In FIG. 5m, the warp dispatch module 116 determines, according to the warp type classification table 106 and the register occupancy status table 112, that dispatching the warp W12 to the streaming processor SP0 of the streaming multiprocessor SM0 will exceed the predetermined upper bound of warp number and the predetermined upper bound of register capacity, but dispatching dispatching the warp W12 to the streaming processor SP1 in the streaming multiprocessor SM0 will not exceed the predetermined upper bound of warp number and the predetermined upper bound of register capacity; thus, the warp dispatch module 116 dispatches the warp W12 to the streaming processor SP1 in the streaming multiprocessor SM0 and updates the number of warps of the streaming processor SP1 in the streaming multiprocessor SM0 to 13 (i.e., 9+4) and the register unit space occupied by the warp to 19 (i.e., 12+3*1+1*2+2*1) in the register occupancy status table 112.

In FIG. 5n, the warp dispatch module 116 determines, according to the warp type classification table 106 and the register occupancy status table 112, that dispatching the warp W13 to the streaming processor SP2 of the streaming multiprocessor SM0 will exceed the predetermined upper bound of warp number and the predetermined upper bound of register capacity, but dispatching dispatching the warp W13 to the streaming processor SP3 in the streaming multiprocessor SM0 will not exceed the predetermined upper bound of warp number and the predetermined upper bound of register capacity; thus, the warp dispatch module 116 dispatches the warp W13 to the streaming processor SP3 in the streaming multiprocessor SM0 and updates the number of warps of the streaming processor SP3 in the streaming multiprocessor SM0 to 10 (i.e., 6+4) and the register unit space occupied by the warp to 17 (i.e., 12+1*2+2*2) in the register occupancy status table 112.

In FIG. 5o, the warp dispatch module 116 determines, according to the warp type classification table 106 and the register occupancy status table 112, that dispatching the warp W14 to any of the streaming processors SP0, SP1, SP2 of the streaming multiprocessor SM0 will exceed the predetermined upper bound of warp number and the predetermined upper bound of register capacity, but dispatching dispatching the warp W14 to the streaming processor SP3 in the streaming multiprocessor SM0 will not exceed the predetermined upper bound of warp number and the predetermined upper bound of register capacity; thus, the warp dispatch module 116 dispatches the warp W14 to the streaming processor SP3 in the streaming multiprocessor SM0 and updates the number of warps of the streaming processor SP3 in the streaming multiprocessor SM0 to 11 (i.e., 6+5) and the register unit space occupied by the warp to 20 (i.e., 12+1*2+2*3) in the register occupancy status table 112. It should be noted that the updated register occupancy status table 112 shows that the register space unit occupied by the warps of the streaming processor SP3 of the streaming multiprocessor SM0 has reached the predetermined upper bound of register capacity.

The warp dispatch module 116 informs the local dispatcher 122 of the streaming multiprocessor SM0 about the dispatching results so that the local dispatcher 122 of the streaming multiprocessor SM0 accordingly assigns the warps W0˜W14 to the respective registers 124 of the streaming processor SP0˜SP3 to complete the dispatching of the thread block TB0. Specifically, the local dispatcher 122 may calculate the corresponding register base addresses based on the warp type classification table 106.

The GPU and related methods of the present disclosure can allocate different sizes of space in the registers of the streaming processor to different types of warps according to the types of the warps when dispatching the warps to the streaming processor, thereby improving the efficiency of register allocation and making the dispatching of warps more flexible and spare.

The foregoing outlines features of several embodiments of the present application so that persons having ordinary skill in the art may better understand the various aspects of the present disclosure. Persons having ordinary skill in the art should appreciate that they may readily use the present disclosure as a basis for designing or modifying other processes and structures for carrying out the same purposes and/or achieving the same advantages of the embodiments introduced herein. Persons having ordinary skill in the art should also realize that such equivalent constructions do not depart from the spirit and scope of the present disclosure, and that they may make various changes, substitutions, and alternations herein without departing from the spirit and scope of the present disclosure.

What is claimed is:

1. A GPU, configured to execute a kernel code, wherein the kernel code comprises a thread block (TB), and the TB comprises a plurality of warps, characterized in that, the GPU comprises:
a plurality of streaming multiprocessor (SMs), each of the SMs comprising:
a plurality of streaming processors (SPs), each of the SPs comprising a register, wherein each of the SPs has a predetermined upper bound of warp number, and the register has a predetermined upper bound of register capacity; and
a global dispatcher, comprising:
a register occupancy status table, configured to record a warp number and an occupancy status of the register of each SP of each SM;
a TB dispatch module, configured to dispatch the TB to a first SM of the plurality of SMs according to a warp type classification table and the register occupancy status table, wherein the warp type classification table records types of the plurality of warps and required register space when the plurality of warps being executed; and
a warp dispatch module, configured to dispatch the plurality of warps to the plurality of SPs of the first SM according to the warp type classification table and the register occupancy status table.

2. The GPU of claim 1, characterized in that, the TB dispatch module determines whether any of the plurality of SMs meets a first condition according to a sum of the required register space of the TB, a sum of the number of the warps of the TB, remaining available register space and a remaining number of acceptable warps of each of the SMs, wherein when the remaining available register space and the remaining number of acceptable warps of any SM of each of the SMs are not less than the sum of the required register space of the TB and the sum of the number of the warps of the TB, respectively, said any SM of each of the SMs meets the first condition.

3. The GPU of claim 2, characterized in that, the TB dispatch module obtains the remaining available register space of each of the SMs according to the register occupancy status table and the predetermined upper bound of register capacity.

4. The GPU of claim 2, characterized in that, the TB dispatch module obtains the remaining number of acceptable warps of each of the SMs according to the register occupancy status table and the predetermined upper bound of warp number.

5. The GPU of claim 2, characterized in that, the TB dispatch module calculates the the sum of the required register space and the sum of the number of the warps of the TB according to the warp type classification table.

6. The GPU of claim 2, characterized in that, the plurality of warps are classified into at least a first type and a second type, the number of a plurality of first type warps corresponding to the first type is a first number, and the register space required by each of the first type warp when being executed is a first register space, and the number of a plurality of second type warps corresponding to the second type is a second number, and the register space required by each of the second type warp when being executed is a second register space, wherein the first register space differs from the second register space.

7. The GPU of claim 6, characterized in that, the TB dispatch module further determines whether any of the plurality of SMs meets a second condition according to the first number, the first register space, the remaining number of acceptable warps and the remaining available register space of each SP of each SM, wherein when the plurality of SPs of any SM of each SM are able to accept all the first type warps of the plurality of warps, said any SM meets the second condition.

8. The GPU of claim 7, characterized in that, the TB dispatch module further determines whether any of the plurality of SMs meets a third condition according to the second number, the second register space, the remaining number of acceptable warps and the remaining available register space of SP of each SM, wherein when the plurality of SPs of any SM of each SM are able to accept all the second type warps of the plurality of warps, said any SM meets the third condition.

9. The GPU of claim 8, characterized in that, the first SM meets the first condition, and the second condition and the third condition.

10. The GPU of claim 8, characterized in that, the warp dispatch module obtains the remaining available register space of each SP of the first SM according to the register occupancy status table and the predetermined upper bound of register capacity.

11. The GPU of claim 8, characterized in that, the warp dispatch module obtains the remaining number of acceptable warps of each SP of the first SM according to the register occupancy status table and the predetermined upper bound of warp number.

12. The GPU of claim 9, characterized in that, the warp dispatch module dispatches the plurality of warps to a plurality of SPs of the first SM one by one according to the warp type classification table and the remaining available register space and the remaining number of acceptable warps of each SP of the first SM.

13. The GPU of claim 12, characterized in that, the warp dispatch module updates the register occupancy status table in real-time according to dispatch result of the plurality of warps.

14. The GPU of claim 1, characterized in that, the plurality of SMs each further comprising local dispatcher, wherein the warp dispatch module dispatches the plurality of warps to the plurality of SPs of the first SM through the local dispatcher of the first SM.

15. The GPU of claim 1, characterized in that, the GPU further receives a kernel launch command, wherein the warp type classification table is in the kernel launch command.

16. The GPU of claim 15, characterized in that, the GPU obtains the kernel code from a memory according to the kernel launch command.

17. A method, characterized in comprising:
receiving a kernel code, wherein the kernel code comprises a TB, and the TB comprises a plurality of warps;
classifying the plurality of warps into a plurality of different types according to a function of the plurality of warps;
analyzing a register space required by each type of the warp when being executed; and
recording in a warp type classification table types of the plurality of warps and required register space when the plurality of warps being executed.

18. The method of claim 17, characterized in that, the plurality of warps are classified into at least a first type and a second type, the number of a plurality of first type warp corresponding to the first type is a first number, and the register space required by each of the first type warp when being executed is a first register space, and the number of a plurality of second type warp corresponding to the second type is a second number, and the register space required by each of the second type warp when being executed is a second register space, wherein the first register space differs from the second register space.

19. The method of claim 17, characterized in further comprising:
adding the warp type classification table into a kernel launch command.

20. The method of claim 18, characterized in further comprising:
transmitting the kernel launch command to the GPU of claim 1.
